(19) United States
(12) Patent Application Publication
(10) Pub. No.: US 2002/0092375 A1
(43) Pub. Date: Jul. 18, 2002

(54) Structure of an anti-slip brake lever

(76) Inventor: Shih I Yao, Taipei (TW)

Correspondence Address: SHIH I Yao, PO Box 82-144, Taipei, TW

(21) Appl. No.: 09/760,664

(22) Filed: Jan. 17, 2001

(51) Int. Cl. B62K 23/06

(52) U.S. Cl. 74/523; 74/502.2

(57) ABSTRACT

An anti-slip brake lever includes a body portion formed with a recess having a plurality of holes, and an anti-slip member including a base and a soft anti-slip layer mounted on one side of the base, another side of the base being provided with a plurality of projections snugly-fitted into the holes, the base being made of a harder material than the anti-slip layer, whereby the anti-slip member can be easily replaced with a new one as desired and required.

### BACKGROUND OF THE INVENTION

1. Field of the Invention

This invention is related to an improvement in the structure of an anti-slip brake lever and in particular to one having a replaceable anti-slip member.

2. Description of the Prior Art

Referring FIGS. 1, 1A and 1B, the conventional anti-slip brake lever is simply made by immersing a brake lever 10 into liquid rubber received in a reservoir 20 so that when the brake lever 10 is taken out of the reservoir 20 and cooled, an anti-slip member 15 will be attached to the brake lever 10 thereby achieving the anti-slip purpose.

However, the anti-slip member 15 is too thin to provide a comfortable feeling to the user and the user will feel very fatigue after holding the brake lever 10 for a long period time. In addition, once the anti-slip member 14 of the brake lever 10 is worn out, the anti-slip member 14 cannot but go to the discard thereby wasting money and natural resources. Furthermore, the cable must be dismantled from the brake lever when the brake lever is replaced thus causing much trouble in operation and therefore increasing the maintenance fee.

Hence, another brake lever with anti-slip function has been developed to obviate the above-mentioned drawbacks. As shown in FIGS. 2, 2A and 2B, the anti-slip brake lever is fabricated by putting a brake lever 30 formed with a recess 31 at one side into a mold composed of an upper half 40 and a lower half 45 and then liquid rubber is injected into the mold to fill into the recess 31 of the brake lever 30 thereby forming an anti-slip member 35.

The anti-slip member 35 obtained by such a method is of sufficient thickness to make the user feel comfortable in holding, but the anti-slip member 35 is permanently attached to the brake lever 30 so that it is impossible to change the color o the anti-slip member 35 and the brake lever 30 has to be discarded when worn out.

Therefore, it is an object of the present invention to provide an anti-slip brake lever which can obviate and mitigate the above-mentioned drawbacks.

### SUMMARY OF THE INVETION

This invention is related to an improvement in the structure of an anti-slip brake lever.

It is the primary object of the present invention to provide an improvement in the structure of an anti-slip brake lever which has a replaceable anti-slip member.

It is another object of the present invention to provide an improvement in the structure of anti-slip brake lever which includes a body portion formed with a recess having a plurality of holes, and an anti-slip member including a base and a soft anti-slip layer mounted on one side of the base, another side of the base being provided with a plurality of projections snugly-fitted into the holes, the base being made of a harder material than the anti-slip layer, whereby the anti-slip member can be easily replaced with a new one as desired and required.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts. Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1, 1A and 1B illustrate the manufacture of a first conventional antislip brake lever;

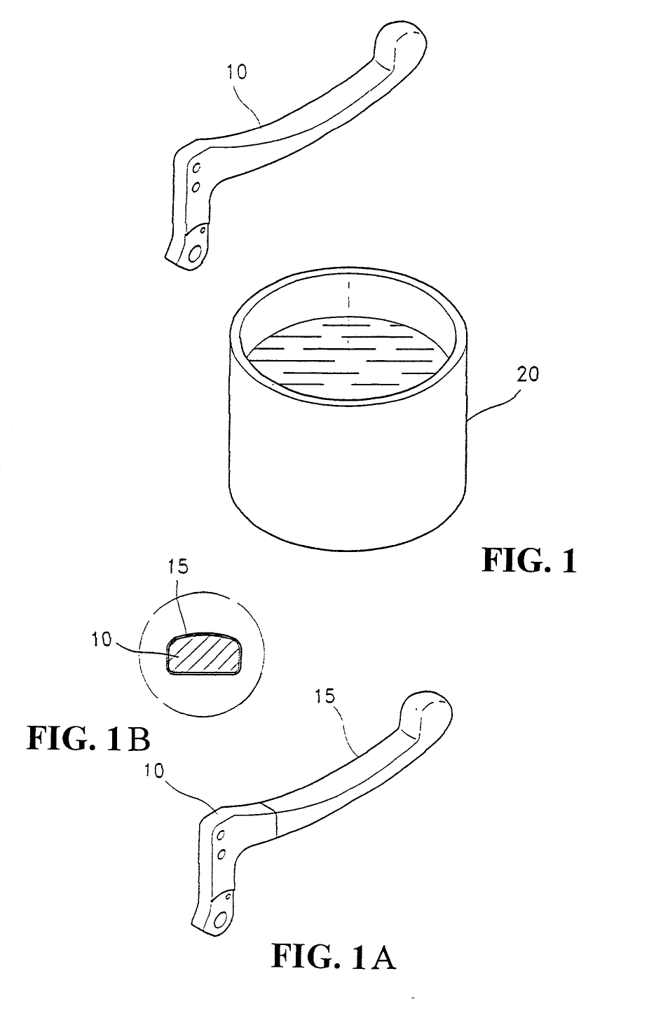

FIGS. 2, 2A and 2B illustrate the manufacture of a second conventional anti-slip brake lever;

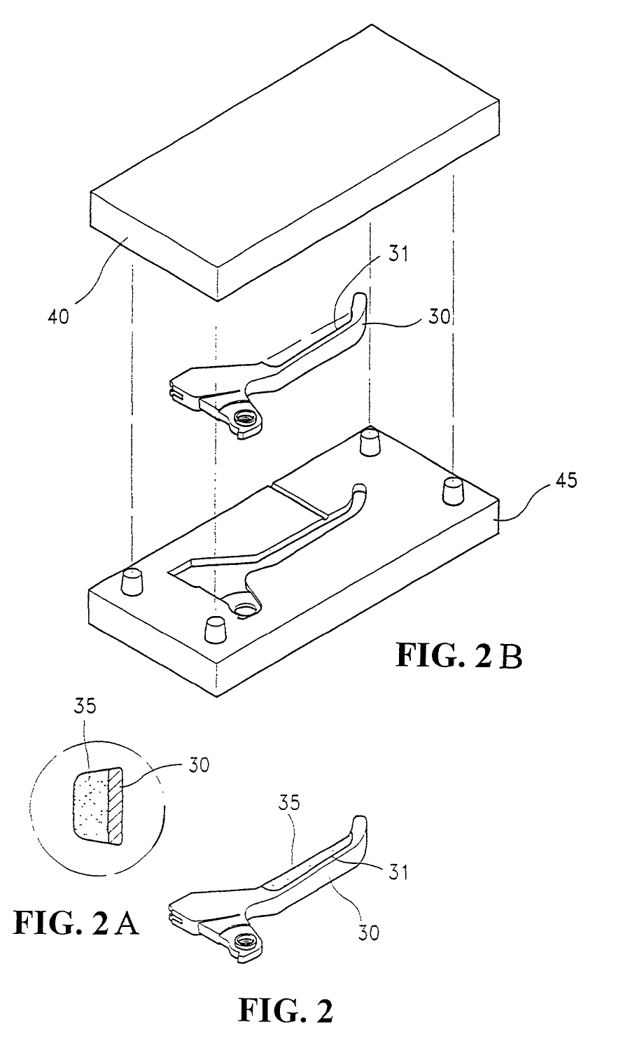

FIGS. 3, 3A and 3B illustrate the structure of an anti-slip brake lever according to the present invention;

FIGS. 4 and 4A illustrate a second embodiment of the present invention; and

FIGS. 5 and 5A illustrate a third embodiment of the present invention.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, such alterations and further modifications in the illustrated device, and such further applications of the principles of the invention as illustrated herein being contemplated as would normally occur to one skilled in the art to which the invention relates.

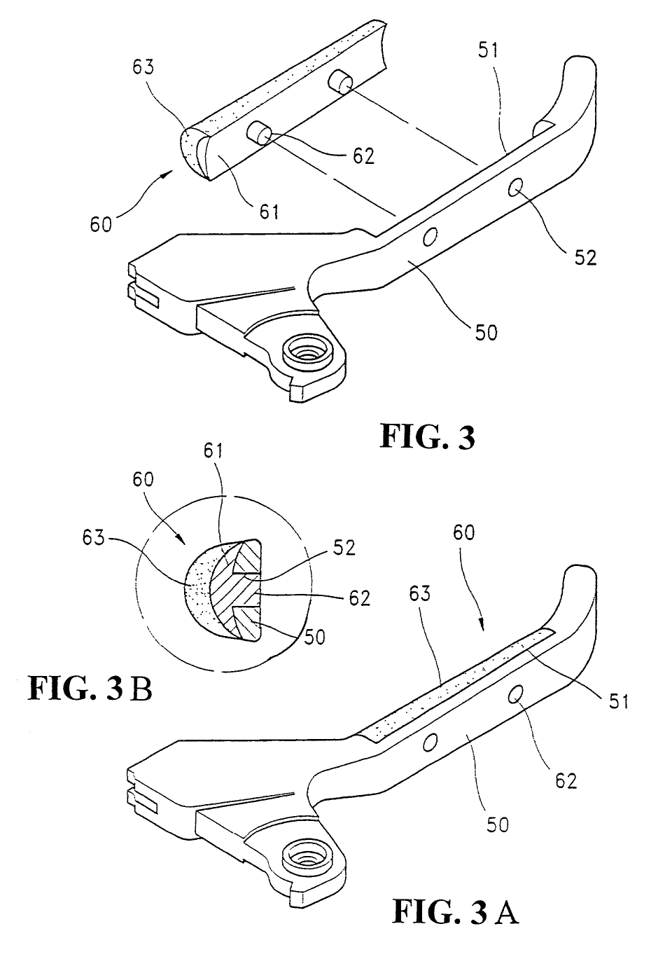

Referning to FIGS. 3, 3A and 3B, the anti-slip brake lever 50 according to the present invention is formed with a recess 51 at one side thereof. The recess 51 has a plurality of through holes 52 for receiving pins 62 of an anti-slip member 63. The anti-slip member 63 includes a base 61 provided at the top with a soft anti-slip layer 63. The base 1 is dimensioned and configured to fit into the recess 51 of the brake lever 50. The base 1 is made of harder material than the soft anti-slip layer 63 so that the braking reaction will be truly transmitted to a hand of a user. The bottom of the base 1 has a plurality of protuberances 62 snugly-fitted the holes 52 of the brake lever 50.

When desired to replace the anti-slip member 63 with a new one or with one having another color, it is only necessary to disengage the anti-slip member 63 from the recess 51 of the brake lever 50 by force and then force a new anti-slip member into the recess 51 of the brake lever 50 thereby enabling the anti-slip member to be changed as desired and/or required. Likewise, when the anti-slip member 63 is worn out, it is only necessary to replace the anti-slip member 63 with a new one without discarding the brake lever 50. Furthermore, it is unnecessary to dismantle the cable from the brake lever when replacing the anti-slip member 63 thereby decreasing the cost in maintenance.

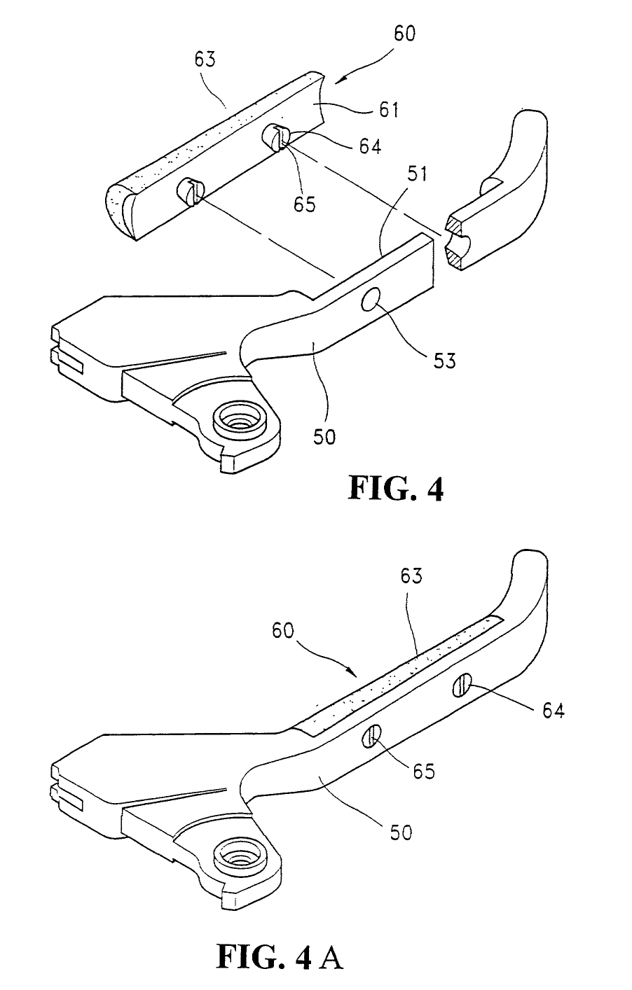

FIGS. 4 and 4 illustrate a second preferred embodiment of the present invention. As shown, the brake lever 50 is formed with a plurality of conical holes 53 and the anti-slip member 60 is provided at the bottom with a plurality of conical projections 64 each having a diametrical groove 65 at the outer end for facilitating the engagement between the conical projections 64 and the conical holes 53. When desired to disengage the anti-slip member 60 from the brake lever 50, it is only necessary to compress the outer end of the conical projections 64 to make it easier to disengage the conical projections 64 from the conical holes 53 of the brake lever 50.

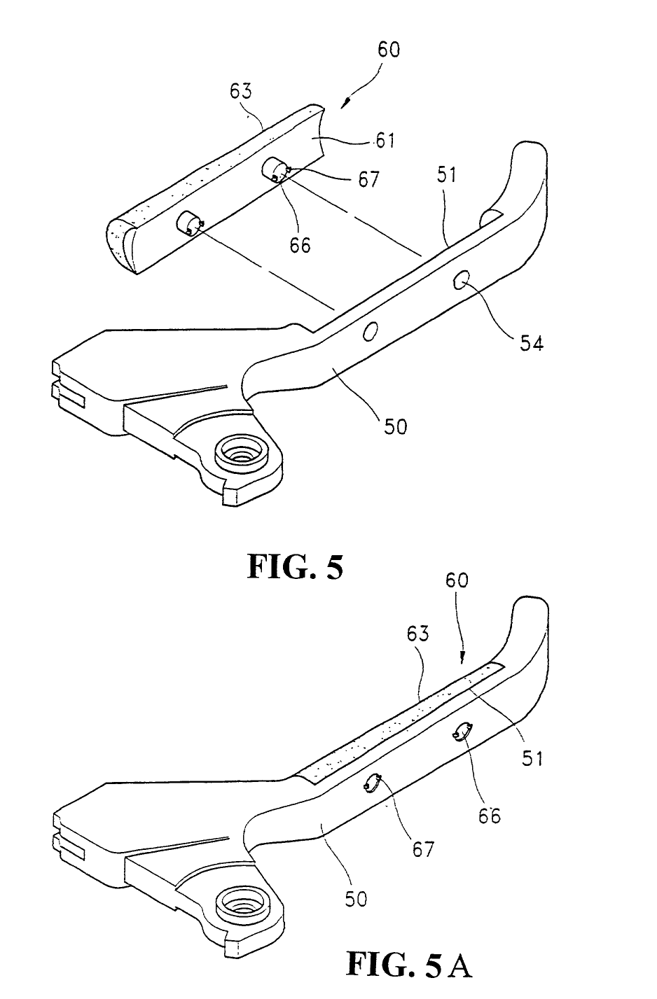

FIGS. 5 and 5A illustrate a third preferred embodiment of the present invention. As illustrated, the

FIGS. 4 and 4 illustrate a second preferred embodiment of the present invention. As illustrated, the brake lever 50 has a plurality of holes 54 and the anti-slip member 60 is provided at the bottom with a plurality of projections 66 each having two radial spring-loaded pins 67 at two opposite sides so that the pins 67 may be compressed into the projection when the projection 66 is inserted into the hole 54 thereby facilitating the engagement between the anti-slip member 60 and the brake lever 50. Then, the pins 67 will go out from the projection 66 to prevent the anti-slip member 60 from disengaging from the brake lever 50. When desired to disengage the anti-slip member 60 from the brake lever 50, it is only necessary to press the pins 67 into the pins 67 and push the projections 66 out of the holes 54.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An anti-slip brake lever comprising:
a body portion formed with a recess having a plurality of holes; and
an anti-slip member including a base and a soft anti-slip layer mounted on one side of said base, another side of said base being provided with a plurality of projections snugly-fitted into said holes, said base being made of a harder material than said anti-slip layer.

2. The anti-slip brake lever as claimed in claim 1, wherein said holes of said body portion and said projections of said anti-slip member are conical in shape, each of said projections having a diametrical groove at another end thereof.

3. The anti-slip brake lever as claimed in claim 1, wherein said projections of said anti-slip member are each provided with two radial spring-loaded pins at two opposite sides thereof.
